(19) United States
(12) Patent Application Publication
(10) Pub. No.: US 2024/0114315 A1
(43) Pub. Date: Apr. 4, 2024

(54) INDOOR POSITIONING SYSTEM USING ULTRA-WIDEBAND COMMUNICATION

(71) Applicant: GOOGLE LLC, Mountain View, CA (US)

(72) Inventor: Dongeek Shin, Mountain View, CA (US)

(21) Appl. No.: 17/637,998

(22) PCT Filed: Oct. 14, 2021
(86) PCT No.: PCT/US21/54929

§ 371 Date: Apr. 20, 2023

(51) Int. Cl. H04W 4/029; G01S 13/87

(52) U.S. Cl. CPC H04W 4/029; G01S 13/878

(57) ABSTRACT

To provide indoor navigation directions to a user, a client device receives (181) a request for indoor navigation directions, and communicates (182) an ultra-wideband (UWB) signal with at least one anchor device in an indoor positioning system having a predetermined location within the indoor positioning system. The client device determines (183) a distance between the client device and the at least one anchor device based on a round trip time associated with the UWB signal, and determines (184) an indoor location of the client device based on (i) the distance between the client device and the at least one anchor device and (ii) the predetermined location for the at least one anchor device. Additionally, the client device generates (185) a set of indoor navigation directions for traversing the destination location, and provides (186) the indoor navigation directions via a user interface of the client device.

### FIELD OF THE DISCLOSURE

This disclosure relates to indoor tracking using ultra-wideband (UWB) communications between a client device and anchor devices included within a building to locate a user.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, digital maps of geographic areas are commonly displayed on computing devices, such as computers, tablets, and mobile phones via mapping applications, web browsers, etc. Many mapping applications provide the user with the ability to select the type of map information or features for viewing as well as to adjust the display of the digital map.

The mapping applications typically use a global positioning system (GPS) sensor to locate the user and provide map information or navigation directions based on the user's current location. However, GPS is known to be inaccurate indoors. As a result, it is difficult to locate a user indoors and provide map information and navigation directions at indoor locations. Moreover, even with the limited indoor location solutions that exist today, generating the floor plans and indoor map data is time consuming and is typically done manually. Each time a new building is constructed or the floor plans change, a user may need to manually input the updated indoor map data for the building, resulting in scalability issues. Additionally, current indoor mapping solutions require extensive hardware installation which is also time consuming and difficult to scale.

### SUMMARY

To generate accurate, scalable indoor maps, an indoor positioning system uses ultra-wideband (UWB) communications between a client device and anchor devices included within a building to locate a user. The anchor devices may be any suitable computing device, such as a home assistant device. Additionally, each anchor device may be at a predetermined location within the building. The client device may then transmit a UWB message to an anchor device and receive a UWB response message back from the anchor device. Then the client device may determine the round trip time (RTT) of the UWB messages. The client device may then determine the distance between the client device and the anchor device based on the RTT. In some implementations, the client device determines distances to at least three anchor devices and then determines its location using the distance and the predetermined locations of the anchor devices using trilateration. In other implementations, the client device includes multiple antennas and determines not only the distance to an anchor device but also the direction of the anchor device. Then the client device determines its location based on the distance, direction, and predetermined location of the anchor device.

Using UWB communications, the indoor positioning system can locate a user with sub-meter accuracy. The distance measurements are also accurate even when there is a wall between the devices as signal attenuation does not affect the time of flight.

An example embodiment of these techniques is a method for determining an indoor location of a user. The method includes communicating, by one or more processors in a client device, an ultra-wideband (UWB) signal with at least one anchor device in an indoor positioning system having a predetermined location within the indoor positioning system, and determining, by the one or more processors, a distance between the client device and the at least one anchor device based on a round trip time associated with the UWB signal. The method further includes determining, using a maximum likelihood estimation (MLE), an indoor location of the client device based on (i) the distance between the client device and the at least one anchor device, (ii) an estimated error in the distance, and (iii) the predetermined location for the at least one anchor device.

Another example embodiments of these techniques is a client device including processing hardware and configured to implement the method above.

Yet another example embodiment of these techniques is a computer-readable memory, which may be non-transitory, coupled to one or more processors and storing instructions thereon. The instructions cause the one or more processors to carry out the method above.

The use of UWB communication between a client device and an anchor device to determine a distance therebetween or a relative location of the client device can provide a more accurate determination of absolute or relative location of the client device. This can allow a user of the client device, or a computer system connected to or associated with the client device, to determine a more accurate real-world position of the client device in a micro-environment, such as inside a building.

In addition to determining the location of the client device using UWB, the method may further comprise controlling one or more electronic devices remotely connected to the client device based on the location of the client device. A computer system connected to or associated with the one or more electronic devices is provided with location data associated with the location of the client device and, in response to receiving the location data, transmits a control signal to the one or more electronic devices to cause the one or more electronic devices to perform an action. The action may be activation or modulation of one or more electronic devices included in the (e.g. indoor) environment. For example, the determined location of the client device may cause the one or more electronic devices to perform an action when the location of the client device is within a predetermined distance of the one or more electronic devices, causing activation or modulation of the one or more electronic devices.

When the computer system connected to or associated with the one or more electronic devices is provided an accurate location of the client device in the environment, this can allow the user to more reliably interact with (for example, control) connected devices in the micro environment based on location of the client device. For example, a lighting system in the micro-environment which is to be operated based on the location of the client device (and hence the user) can be more reliably controlled by the computer system based on the location of the client device.

To calibrate the locations of N anchor devices within the indoor positioning system, each anchor device transmits a UWB communication to each other anchor device to determine distances between each pair of anchor devices within the indoor positioning system. The indoor positioning system then generates an N×N matrix of distance measurements between each pair of anchor devices, e.g., the distance between the first anchor device and the first anchor device, the distance between the first anchor device and the second anchor device, the distance between the first anchor device and the Nth anchor device, etc. Then the indoor positioning system analyzes the matrix to transform the distance measurements to a set of locations of each of the anchor devices. The indoor positioning system reconstructs an absolute network topology of the anchor device based on the set of locations. Then the indoor positioning system stores the absolute network topology for use as predetermined locations of the anchor devices for determining the indoor location of a client device and hence a user.

In addition to automatically determining the locations of the anchor devices and locating a user within a building, the indoor positioning system automatically generates floor plans. In this manner, the indoor positioning system may provide navigation directions to various locations within the building according to the floor plans. The indoor positioning system may also receive labels for rooms within the building and may perform actions based on conditions occurring within the rooms, such as a particular event occurring within the boundaries of a particular room. For example, a user may label a room as a kitchen and request the kitchen lights to automatically turn on anytime someone enters the kitchen.

To automatically generate the floor plans, the indoor positioning system obtains indoor location histories for users indicating their locations within the building over time. For example, the indoor location histories may include each of the locations traversed by a first user over a two hour time period, each of the locations traversed by a second user over a one hour time period, etc. Then the indoor positioning system may infer the locations of walls, entrances, and/or exits from rooms within the indoor positioning system based on the indoor location histories. For example, the indoor positioning system may cluster the locations into multiple clusters and determine that each cluster represents a different room. The indoor positioning system may identify walls as existing in areas (e.g. between the rooms or at the boundary of the building) that are not included in the indoor location histories and therefore have not been visited by the users. Locations where there is a bottleneck between areas in the indoor location histories may be identified as the locations of entrances/exits between rooms.

Automatic generation of floor plans in this way can provide a more accurate and reliable mapping of a micro-environment. The resulting floor plans can have higher fidelity than, for example, manually generated floor plans or those obtained from existing (e.g. third party) records, because they are generated based on the layout of the various rooms, zones or areas as determined by location histories of users moving in the internal spaces in the real world. If a floorplan in a building is reconfigured, for example by changing the position of internal walls, the generated floorplans may be automatically updated due to changes in limitation of movement of the client device in the micro-environment. Hence, the floor plans are more easily and reliably kept up to date.

Furthermore, automatically generated floor plans can be combined with both (i) accurate determination of the location of the client device using UWB as described herein and (ii) activation or modulation of electronic devices as described herein to provide a synergistic effect. For example, by determining that the client device is in a particular room or zone represented in the floor plan, electronic devices in said room or zone can be activated or modulated only when the client device is present in that room. This can address problems associated with a proximity-based system. For example, in a proximity-based system without any floor plan information, electronic devices (e.g. lighting, or visual or audio equipment) may be activated when the client device is close to, but not present in the room in which those electronic devices are located, causing inappropriate use of those electronic devices and/or waste of energy associated with powering the electronic devices.

One example embodiment of these techniques is a method performed by a client device for presenting indoor navigation directions to a user. The method can be executed by processing hardware and includes receiving a request for indoor navigation directions to a destination location within a building. The method also includes communicating an ultra-wideband (UWB) signal with at least one anchor device in an indoor positioning system having a predetermined location within the indoor positioning system. The method also includes determining a distance between the client device and the at least one anchor device based on a RTT associated with the UWB signal. The method also includes determining an indoor location of the client device based on (i) the distance between the client device and the at least one anchor device and (ii) the predetermined location for the at least one anchor device. The method also includes generating a set of indoor navigation directions for traversing from the indoor location of the client device to the destination location along a route. The method also includes presenting the indoor navigation directions via a user interface of the client device.

By using UWB communication between a client device and the at least one anchor device, more accurate navigational information can be provided to a user in a micro-environment. For example, the navigation system can measure the user's position via UWB communication and, on the basis of these measurements, provide the user with information aimed at enabling the user to manage the technical task of moving to a desired destination within the micro-environment in a more efficient manner.

A further example embodiment of these techniques is a client device including processing hardware and configured to implement the method above.

Yet another example embodiment of these techniques is a computer-readable memory, which may be non-transitory, coupled to one or more processors and storing instructions thereon. The instructions cause the one or more processors to carry out the method above.

Another example embodiment of these techniques is a system for providing indoor navigation directions to a user. The system includes one or more anchor devices. Each anchor device is configured to receive a UWB signal from a client device, and provide a UWB response signal to the client device to cause the client device to determine an indoor location of the client device based on a round trip time of the UWB signal and the UWB response signal. The system also includes a server device including one or more processors, and a memory including computer executable instructions. The instructions, when executed by the one or more processors, cause the server device to receive a request for indoor navigation directions from the indoor location of the client device to a destination location within a building, generate a set of indoor navigation directions for traversing from the indoor location of the client device to the destination location along a route, and provide the indoor navigation directions to the client device.

Another example embodiment of the techniques of this disclosure is a method for calibrating positions/determining locations of ultra-wideband (UWB) anchor devices in an indoor positioning system. The method includes obtaining distance measurements between each pair of N anchor devices in the indoor positioning system. Each distance measurement is determined based on a round trip time of a UWB signal communicated between the pair of anchor devices. Additionally, the method includes determining a location of each of the anchor devices within the indoor positioning system using the distance measurements, and reconstructing an absolute network topology of the anchor devices using the determined locations of the UWB anchor devices. The absolute network topology is used to determine a location of a client device within the indoor positioning system.

Calibrating the locations of the anchor devices using the methods described herein can provide a more accurate network topology and can reduce set up times compared with other methods, such as distributing anchor devices in predetermined locations.

A further example embodiment of these techniques is a computing device including processing hardware and configured to implement the method above.

Yet another example embodiment of these techniques is a computer-readable memory, which may be non-transitory, coupled to one or more processors and storing instructions thereon. The instructions cause the one or more processors to carry out the method above.

Another example embodiment of the techniques of this disclosure is a method for automatically generating an indoor floor plan. The method includes obtaining indoor location histories for one or more users within an area of a building based on determined indoor locations of the one or more users over time, clustering the determined indoor locations in the indoor location histories into a plurality of clusters for example, based on proximity to a centroid of each cluster, and generating the indoor floor plan by dividing the area into rooms in accordance with the plurality of clusters. The method also includes storing the indoor floor plan for use in indoor mapping.

A further example embodiment of these techniques is a computing device including processing hardware and configured to implement the method above.

Yet another example embodiment of these techniques is a computer-readable memory, which may be non-transitory, coupled to one or more processors and storing instructions thereon. The instructions cause the one or more processors to carry out the method above.

### BRIEF DESCRIPTION OF THE DRAWINGS

FIG. 1A is a block diagram of an example indoor positioning system that implements the techniques of this disclosure;

FIG. 1B is an example message sequence that can be performed by a pair of anchor devices operate in the system of FIG. 1A, for determining a distance between the anchor devices;

FIG. 1C is an example message sequence that can be performed by the system of FIG. 1A, for measuring a round trip time of messages exchanged between a pair of anchor devices or a UE and an anchor device;

FIG. 1D illustrates a flow diagram that can be performed by the system of FIG. 1A for presenting indoor navigation directions;

FIG. 2 is a schematic diagram of the software components of the indoor positioning system;

FIG. 3 is an example Euclidean Distance Matrix indicating the square of the distances between each pair of anchor devices;

FIG. 4 is an example network topology of the indoor locations of each of the anchor devices, which may be used for determining an indoor location of a client device based on its distance from each anchor device and the indoor location of each anchor device;

FIG. 5 is a flow diagram of an example method for calibrating positions of anchor devices in an indoor positioning system, which can be implemented in a server device;

FIG. 6 is a schematic diagram illustrating an example trajectory of a user within a building determined using UWB signals communicated between the user's client device and the anchor devices, which may be used to generate an indoor floor plan;

FIG. 7 is a schematic diagram illustrating the clustering of the trajectories of several users within the building into several clusters corresponding to different rooms in the building;

FIG. 8 is a schematic diagram of an example indoor floor plan generated by clustering user's location histories;

FIG. 9 is an example display which may be presented on a user interface of a client device of an indoor floor plan for labeling rooms in the indoor floor plan;

FIG. 10 is an example indoor navigation display which may be presented on a user interface of a client device of example indoor navigation directions from the user's current location to a destination location; and

FIG. 11 is a flow diagram of an example method for automatically generating an indoor floor plan, which can be implemented in a server device.

### DETAILED DESCRIPTION OF THE DRAWINGS

Generally speaking, the techniques of this disclosure allow a user equipment (UE), interchangeably referred throughout this disclosure as “client device,” to communicate with one or more anchor devices using a radio technology that is suitable for short-range, high-bandwidth communications over a large portion of a radio spectrum. One such non-limiting radio technology is ultra-wideband (UWB). The UE and one or more anchor devices can be located in an indoor environment (i.e., in a building, such as a home, mall, sports arena, museum, theme park, or any suitable indoor environment in which at least a portion of the environment is located indoors). When the UE communicates signals with one or more anchor devices over UWB for example, the UE can determine its location relative to the one or more anchor devices based on a measurement of the time of flight of those signals. Further, if the location of each of the one or more anchor devices is known, the UE can determine its absolute location. Compared to conventional GPS-based location determination techniques, the UE is able to determine its location within the indoor environment with sub-meter accuracy. The UE may be a smart phone, a tablet computer, a laptop computer, a desktop computer, a wearable device such as a smart watch or smart glasses, or any suitable client computing device.

The techniques of this disclosure also allow a network server to communicate with the UE and one or more anchor devices. The network server can collect various data related to the locations of the UE and one or more anchor devices to generate a floor plan of the indoor environment. The UE can communicate with the network server to not only access the generated floor plan, but also to provide navigation directions (e.g., from the current location of the UE to a destination within the indoor environment) that is desired by a user associated with the UE.

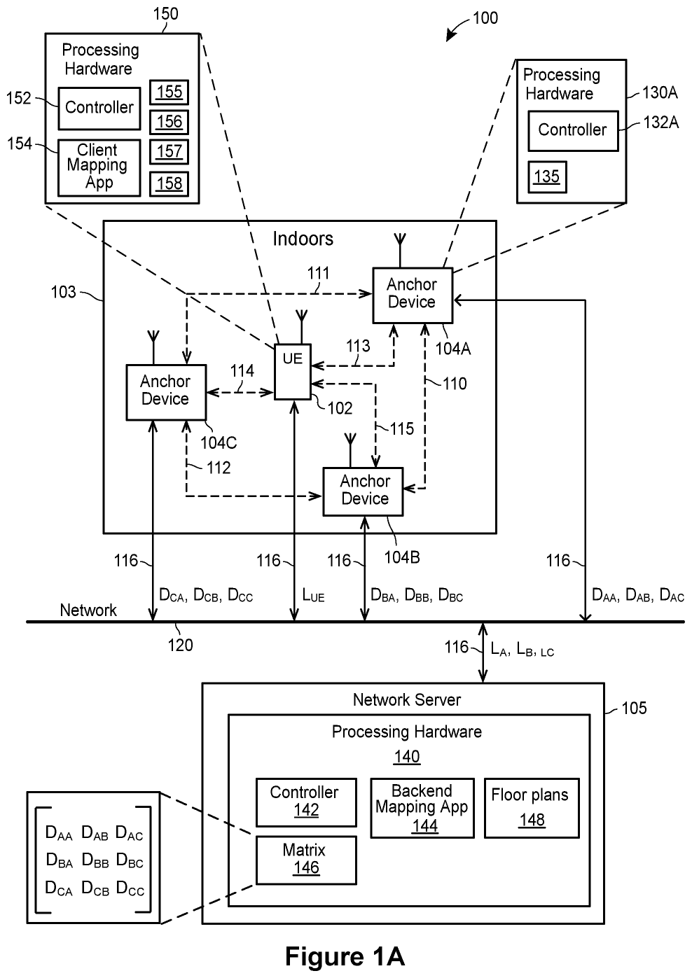

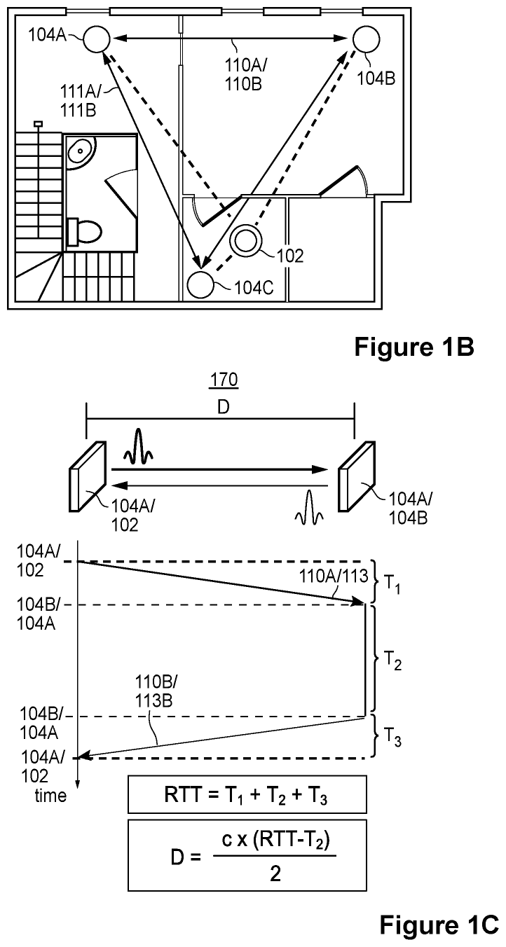

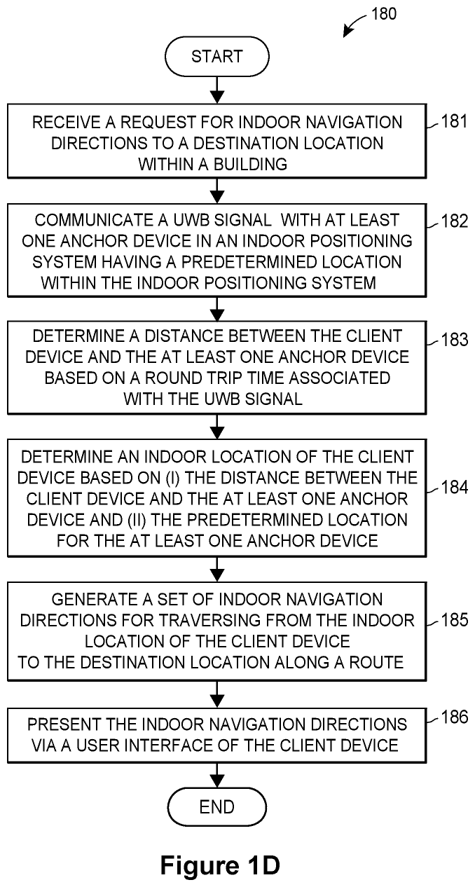

FIG. 1A depicts an example indoor positioning system 100 that can implement the techniques of this disclosure. The indoor positioning system 100 includes UE 102, as well as anchor devices 104A, 104B and 104C, each communicatively coupled to a network server 105 via a network 120. The network 120 in general can include one or more wired and/or wireless communication links (e.g., communication links 116) and may include, for example, a wide area network (WAN) such as the Internet, a local area network (LAN), a cellular telephone network, or another suitable type of network.

The UE 102 can be in range to communicate over UWB with one or more of the anchor devices 104A, 104B, 104C that are spatially-separated and located in an indoor environment 103 (e.g., a building). The anchor devices 104A, 104B, 104C themselves can be in range to communicate over UWB amongst each other, and to the network server 105. Although a single UE and three anchor devices are illustrated in the example indoor positioning system 100, generally speaking, the indoor positioning system 100 can include M UEs and N anchor devices, where both M and N are equal to or greater than one. Although the examples disclosed herein refer specifically to specific radio technology (UWB), in general the techniques of this disclosure can also apply to other suitable radio technologies for short-range, high-bandwidth communications over a large portion of a radio spectrum.

Each of the anchor devices 104A, 104B, 104C can be any suitable type of computing device capable of wireless communications, such as a home assistant device (e.g., Google Home, Google Nest, Amazon Echo), a tablet computer, a wireless hotspot, a femtocell, or a broadband router. The anchor device 104A includes processing hardware 130A, which can include one or more general-purpose processors (e.g., central processing units (CPUs)) and a computer-readable memory (e.g., random access memory (RAM), flash memory, read-only memory (ROM)) storing machine-readable instructions executable on the one or more general-purpose processor(s), and/or special-purpose processing units.

Anchor Device Location Determination Techniques based on a Signal's Time of Flight

The processing hardware 130A in the example implementation in FIG. 1A includes a controller 132A that is configured to determine a distance between the anchor device 104A and itself (e.g., D_{AA}=0) and/or at least another anchor device included in the indoor positioning system 100 based on a measurement of the time of flight of a signal exchanged between them. For example, as illustrated in FIG. 1A and with reference to FIGS. 1B and 1C, the controller 132A can transmit a first UWB signal 110A over UWB link 110 to anchor device 104B, receive a first UWB response signal 110B over UWB link 110 back from the anchor device 104B, and calculate a distance (D_{AB}) between the anchor device 104A and the anchor device 104B based on a measurement of the RTT of the first UWB signal 110A and the first UWB response signal 110B. That is, the controller 132A can calculate RTT as T₁+T₂+T₃, where T₁ is the amount of time it takes for the first UWB signal 110A to be sent from a transmitter (e.g., controller 132A) of the anchor device 104A to a receiver of the anchor device 104B, T₂ is the amount of time it takes for the anchor device 104B to generate a reply, and T₃ is the time duration in which a transmitter (e.g., controller 132A) of the anchor device 104A sends the first UWB response signal 110B (as the reply) back to a receiver (e.g., controller 132A) of the anchor device 104A. Then, the controller 132A can calculate D_{AB} as ½ of c×(RTT−T₂), where c is the speed of light. In some implementations, the controller 132A can also transmit a second UWB signal 111A over UWB link 111 to anchor device 104C, receive a second UWB response signal 111B over UWB link 111 back from the anchor device 104C, and calculate a distance (D_{AC}) between the anchor device 104A and the anchor device 104C based on a measurement of the RTT of the second UWB signal 111A and the second UWB response signal 111B, as described above.

The processing hardware 130A can also include a network interface 135. The network interface 135 can include one or more communication interfaces such as hardware, software, and/or firmware for enabling communications with the network server 105 via a cellular network, a WiFi network, or any other suitable network such as the network 120. For example, using the network interface 135, the anchor device 104A can send any one of D_{AA}, D_{AB}, D_{AC} to the network server 105 or to one of the anchor devices 104A-104C, such as a lead anchor device that analyzes the distance measurements to determine the locations of the anchor devices 104A-104C. The lead anchor device may be one of the anchor devices 104A-104C that performs additional processing along with facilitating distance measurements. For example, the lead anchor device may determine the locations of the anchor devices 104A-104C based on the distance measurements.

Although not shown, anchor devices 104B, 104C can include processing hardware similar to processing hardware 130A. As such, using UWB links (e.g., UWB links 110, 111, 112), any one of the anchor devices 104B, 104C can also measure a distance to itself (e.g., D_{BB}, D_{CC}) and/or at least another anchor device (e.g., D_{BA}, D_{BC}, D_{CA}, D_{CB}), and send such measurements to the network server 105, in a similar manner as described above. More generally, if there are N anchor devices, a total of N×(N−1)/2 unique pairwise distance measurements are determined, where the distance from a first anchor device to a second anchor device (e.g., D_{AB}) is the same as the distance from the second anchor device to the first anchor device (e.g., D_{BA}). The anchor devices 104A-104C may transmit each of the distance measurements to a lead anchor device (e.g., anchor device 104A) or may transmit the distance measurements to the network server 105.

The network server 105 can be any suitable type of computing device capable of communicating with each of the anchor devices 104A, 104B, 104C, as well as the UE 102, over the network 120. The network server 105 includes processing hardware 140, which can include one or more general-purpose processors (e.g., CPUs) and a computer-readable memory (e.g., RAM, flash memory, ROM) storing machine-readable instructions executable on the one or more general-purpose processor(s), and/or special-purpose processing units. The processing hardware 140 in the example implementation in FIG. 1A includes a controller 142 that is configured to calibrate the locations of the one or more anchor devices 10A, 104B, and/or 104C within the indoor positioning system 100. In some implementations, the controller 142 can generate a matrix 146 including elements corresponding to the distance measurements described above. For example, the processing hardware 140 can receive, over communication links 116 via the network 120, measured distances (e.g., D_{AA}, D_{AB}, D_{BA}, D_{BB}) from anchor devices 104A, 104B to subsequently generate a matrix (e.g., 2×2 matrix) of distance measurements. In some implementations, as illustrated in FIG. 1A, the processing hardware 140 can receive all of the measured distances (e.g., D_{AA}, D_{AB}, D_{AC}, D_{BA}, D_{BB}, D_{BC}, D_{CA}, D_{CB}, D_{CC}) from all of the anchor devices 104A, 104B, 104C over communication links 116 via the network 120 to subsequently generate a matrix (e.g., 3×3 matrix) of distance measurements. As such, at least in some implementations, the network server 105 can generate an N×N matrix of distance measurements between each pair of anchor devices. In any event, the controller 142 is further configured to analyze the generated matrix 146 to transform the distance measurements to a set of locations L_{A}, L_{B}, L_{C} of each of the respective anchor devices 104A, 104B, 104C that provided a distance measurement. Based on the set of locations, the controller 142 can reconstruct an absolute network topology that represents the locations of the anchor devices. As such, if all three of the anchor devices 104A, 104B, 104C included in the indoor positioning system 100 provide distance measurements to the controller 142, the controller 142 can determine and store the absolute network topology for the anchor devices 104A, 104B, 104C in memory.

### UE Location Determination Techniques Based on a Signal's Time of Flight

The UE 102 includes processing hardware 150, which can include one or more general-purpose processors (e.g., CPUs) and a computer-readable memory (e.g., RAM, flash memory, ROM) storing machine-readable instructions executable on the general-purpose processor(s), and/or special-purpose processing units. The processing hardware 150 in the example implementation of FIG. 1A includes a controller 152 that is configured to determine a distance between the UE 102 and any one of the anchor devices 104A, 104B, 104C included in the indoor positioning system 100 based on a measurement of the time of flight associated with a signal exchanged between them. For example, as illustrated in FIG. 1A and with reference to a message sequence 170 illustrated in FIG. 1C, the controller 152 can transmit a first UWB signal 113A over UWB link 113 to anchor device 104A, receive a first UWB response signal 113B back from the anchor device 104A over UWB link 113, and calculate a distance (D_{UA}) between the UE 102 and the anchor device 104A based on a measurement of the RTT of the first UWB signal 113A and first UWB response signal 113B. That is, the controller 152 can calculate RTT as T₁+T₂+T₃, where T₁ is the amount of time it takes for the first UWB signal 113A to be sent from a transmitter (e.g., controller 152) of the UE 102 to a receiver (e.g., controller 132A) of the anchor device 104A, T₂ is the amount of time it takes for the anchor device 104A (e.g., controller 132A) to generate a reply, and T₃ is the time duration in which a transmitter (e.g., controller 132A) of the anchor device 104A sends the first UWB response signal 113B (as the reply) back to a receiver (e.g., controller 152) of the UE 102. Then, the controller 152 can calculate D_{UA} as ½ of c×(RTT−T₂), where c is the speed of light. In some implementations, the UE 102 can be equipped with multiple antennas to determine not only D_{UA} but also the direction of the anchor device 104A, so that the controller 152 can determine the location (L_{UE}) of the UE 102 based on the distance and direction. For example, the UE 102 may determine the direction of the anchor device 104A by receiving the first UWB response signal 113B at each of its antennas, where the antennas are located at different positions within the UE 102. The UE 102 may then determine the direction of arrival of the first UWB response signal 113 based on a time difference at which each of the antennas received the first UWB response signal 113. In some implementations, the UE 102 may include a compass, magnetometer, gyroscope, accelerometer, and/or other sensors to determine its orientation. Then the UE 102 may determine the direction of arrival of the first UWB response signal 113 based on a time difference at which each of the antennas received the first UWB response signal 113 and based on the orientation of the UE 102.

In other implementations, the anchor device 104A can be equipped with multiple antennas for determining the direction of the UE 102 relative to the anchor device, so that the controller 152 can determine the location (L_{UE}) of the UE 102 based on the distance and direction. For example, the UE 102 may transmit the first UWB signal 113A which is received at multiple antennas at the anchor device 104A. The anchor device 104A may then transmit multiple UWB response signals 113B back to the controller 152 in response to receiving the first UWB signal 113 at each antenna with indications of the positions of the antennas and indications of which antenna received the first UWB signal 113A at which time. In other implementations, the anchor device 104A may determine the direction of arrival of the UWB signal 113A based on when the UWB signal 113A is received at each antenna and provide a UWB response signal 113B back to the controller 152 and an indication of the direction of the UE 102.

In some implementations, the controller 152 can determine the location (L_{UE}) of the UE 102 based on the distances to the respective anchor devices 104A, 104B 104C. For instance, in addition to determining D U A described above, the controller 152 can transmit second and third UWB signals over respective UWB links 114, 115 to respective anchor devices 104B and 104C, receive the second and third UWB response signals over the respective UWB links 114, 115 back from the respective anchor devices 104B and 104C, and calculate distances (D_{UB}, D_{UC}) to the respective anchor devices 104B and 104C, similar to the manner in which the controller 152 can calculate D_{UA} as described above.

Using D_{UA}, D_{UB}, D_{UC}, the relative location of the UE 102 can be determined utilizing trilateration techniques as known in the art. Generally speaking, if N is equal to or greater than 2, the relative location (L_{UE}) of the UE 102 can be determined utilizing multilateration techniques as known in the art.

When N is equal to 3, the location of the UE can be determined in 2 dimensions (i.e. a floor on which the anchor devices are located). When N is greater or equal to 4, the location of the UE can be determined in 3 dimensions, for example to determine the UE location in a multi-storey building.

In some implementations, a second UE connected remotely to a first UE determines the relative location of the first UE based on distances from the first UE to respective anchor devices. In this case, a controller of the second UE transmits signals to the first UE to cause the first UE to carry out the method steps described herein for determining the relative location of the first UE. That is, the second controller transmits signals to the first UE to cause the first controller to: transmit UWB signals over respective UWB links to respective anchor devices; receive respective UWB response signals over the respective UWB links back from the respective anchor devices, and calculate distances from the first UE to the respective anchor devices.

Alternatively, the controller of the first UE independently determines the location of the first UE and the controller of the second UE transmits a request to the controller of the first UE to transmit a location of the first UE to the second UE. The location of the first UE is then transmitted to the second UE and may be subsequently provided to the user via a user interface of the second UE, for example a display of the second UE.

Thus, using UWB signals, a more accurate location of the first UE can be determined remotely, for example if the first UE has been misplaced in the microenvironment and the user wishes to find the first UE. To protect user privacy, the location of the first UE is determinable only by an authorized user of the first UE. For example, the access to the location of the first UE via the second UE may only be available to an authorized user of the first UE via a password-protected online user account.

The methods of automatically generating an indoor floor plan described herein may combine synergistically with the methods of locating a misplaced UE as described herein. For example, the generation of an indoor floor plan coupled with the location of the first UE via the second UE can direct a user to the room (and/or a location relative to the room) in which the first UE is located, thereby enabling a misplaced first UE to be located with greater speed and efficiency. This can address problems associated with a proximity-based system or a location based system without floor plan information. For example, in a proximity-based system or a location based system without any floor plan information, the location of a misplaced client device may be determined to be in a location which is close to the boundary between two rooms, but the information concerning which room the client device is in is missing and so the user may begin the search in the wrong room based on the location information.

In some cases, multilateration techniques may be insufficient to determine L_{UE} if distances from the UE 102 to the N anchor devices are noisy (e.g., contain errors). Errors may arise from inefficiencies in analog-to-digital converters (ADCs) included in any one of the UE 102 or anchor devices 104A, 104B 104C, or radio path non-linearity present in the distances between the UE 102 and each of the anchor devices 104A, 104B 104C, for example. In these cases, the UE 102 (e.g., the controller 152) in some implementations can employ a maximum likelihood estimation (MLE) algorithm to determine the location (L_{UE}) of the UE 102 based on the distances to the respective anchor devices 104A, 104B 104C and estimated errors in such distances. With the assumption that time of flight values may be corrupted with additive Gaussian noise, the maximum likelihood estimation (MLE) algorithm can be devised to solve an optimization problem that maximizes a likelihood function over coordinate parameters given pairwise distance data (e.g., D_{UA}, D_{UB}, D_{UC}). In other words, the MLE algorithm seeks to model the pairwise distance data to account for the estimated error. The MLE algorithm to maximize v can be expressed as

$${\sum }_{k = 1}^{N} ℒ ( v ; {v}_{k} , c \cdot \frac{{t}_{k}}{2} ) ,$$

where v k indicates the locations of the N (e.g., N=3) anchor devices (e.g., L_{A}, L_{B}, L_{C}), c is the speed of light, and tₖ indicates RTT-T₂, such that

$$c \cdot \frac{{t}_{k}}{2}$$

is the approximate distance from the UE 102 to the kth anchor device (e.g., D_{UA}, D_{UB}, D_{UC}).

$$ℒ ( v ; {v}_{k} , c \cdot \frac{{t}_{k}}{2} )$$

can be determined based on the following equation:

$$ℒ ( v ; {v}_{k} , c \cdot \frac{{t}_{k}}{2} ) = exp \{ {( {‖ v - {v}_{k} ‖}_{2} - c \cdot \frac{{t}_{k}}{2} )}^{2} / 2 {σ}^{2} \} ,$$

where σ is the noise level or error in the system.

The processing hardware 150 in the example implementation of FIG. 1A can include a network interface 155, a user interface 156, an input/output (I/O) interface 157, and an operating system (OS) 158. The network interface 155 can include one or more communication interfaces such as hardware, software, and/or firmware for enabling communications with the network server 105 via a cellular network, a WiFi network, or any other suitable network such as the network 120. For example, the controller 152 can receive the locations (L_{A}, L_{B}, L_{C}) of the respective anchor devices 104B and 104C as predetermined by the network server 105. Using D_{UA}, D_{UB}, D_{UC}, L_{A}, L_{B}, and L_{C}, the UE 102 can utilize trilateration techniques as known in the art to determine its absolute location. As another example, the controller 152 can transmit the L_{UE} to the network server 105 over communication links 116 via the network 120, so that the network server 105 can track the location of the UE 102.

The user interface 156 can include one or more input devices configured to receive user commands, such as a touchscreen, a keyboard, a mouse, microphone, a camera, etc. and one or more output devices configured to provide visual, audio, and/or tactile output, such as touchscreen or a speaker. The OS 158 can be any suitable mobile or genera-purpose OS. In addition, the processing hardware 150 can store one or more applications that communicate (e.g., transmitting data, receiving data, or both) data via the network 120, including a client mapping application 154, which will be described in further detail below. The OS 158 may include application programming interface (API) functions that allow applications to access information from components of the UE 102. The UE 102 may also include components not shown in FIG. 1A, such as a graphics processing unit (GPU).

### Floor Plans and Navigation Directions

In some implementations, the indoor positioning system 100 can automatically generate floor plans and navigation directions to various locations within the indoor environment 103 according to the floor plans. In one such implementation, the processing hardware 140 of the network server 105 can include a backend mapping application 144 that can be executed by one or more processors to collect location data (i.e., L_{UE}), e.g., in real time, from the UE 102 (and updated values of L_{UE} if the UE 102 changes its location) via the network 120. If there are M UEs located in the indoor environment 103, the backend mapping application 144 can collect, at a minimum, M instances of L_{UE} associated with the respective M UEs. Over time, using the location data, the backend mapping application 144 can determine indoor location histories for the M UEs, including UE 102. For example, the indoor location histories may include each of the locations traversed by UE 102 over a two hour time period, each of the locations traversed by a second UE over a one hour time period, etc. In some implementations, based on the indoor location histories, the backend mapping application 144 can determine current or average pedestrian traffic data on a path or area within the indoor environment 103. In some implementations, based on the indoor location histories, the backend mapping application 144 can generate floor plans 148 by inferring the locations of various features of the indoor environment 103, such as walls, entrances, exits, rooms, etc.

For example, the backend mapping application 144 can determine that areas that are not included in the indoor location histories (and therefore have not been visited by a user associated with the UE 102) are indicative of the existence of walls, and subsequently generate indoor feature data that represents walls in these areas. As another example, the backend mapping application 144 can cluster areas that are included in the indoor location histories into multiple clusters, determine that each cluster represents a different room, and subsequently generate indoor feature data that represents rooms in the location of these clusters. As yet another example, the backend mapping application 144 can determine that areas included in the indoor location histories areas that correspond to a bottleneck of M UEs are indicative of the location of entrances or exits between rooms, and subsequently generate indoor feature data that represents entrances or exits in these areas. The backend mapping application 144 can generate floor plans 148 based on the various indoor feature data. The backend mapping application 144 can also store such indoor feature data and the floor plans 148 in memory. Over time, as new information becomes available (e.g., more location data, indoor feature data), the backend mapping application 144 may generate several versions of the floor plans 148 and continuously refine the floor plans 148. An administrator of the network server 105 may also edit or customize the floor plans 148 via the backend mapping application 144. For example, the administrator can use the backend mapping application 144 to select, among the floor plans 148, a particular floor plan for an indoor environment that is open to the general public (e.g., a sports stadium, a mall), display the particular floor plan, and superimpose (e.g., using a mouse) labels (e.g., “field,” “Section 324,” “Restrooms,” “upper deck,” name of a business or other points of interest (POI), etc.) onto the particular floor plan.

In some implementations, the floor plans 148 may be accessible by the UE 102 (or any of the M UEs). In one such implementation, the processing hardware 150 of the UE 102 can include a client mapping application 154 that can be executed by one or more processors to access the floor plans 148 via the network 120. Although FIG. 1A illustrates the client mapping application 154 as a standalone application, the functionality of the client mapping application 154 also can be provided in the form of an online service accessible via a web browser executing on the UE 102, as a plug-in or extension for another software application executing on the UE 102, etc. The client mapping application 154 generally can be provided in different versions for different respective operating systems.

In some implementations, the client mapping application 154 can edit or customize the floor plans 148, similar to the manner in which the backend mapping application 144 can edit or customize the floor plans 148, as described above. For example, a user of the UE 102 can use the client mapping application 154 to select (e.g., via user interface 156), among the floor plans 148, a particular floor plan for an indoor environment that is private (e.g., the user's home), display (e.g., via user interface 156) the particular floor plan, and superimpose (e.g., via user interface 156) labels (e.g., “kitchen,” “master bedroom,” “basement,” “bedroom #1,” “bedroom #2,” etc.) onto the particular floor plan. In some implementations, using the client mapping application 154 and/or other application related to smart home configuration (e.g., Amazon Alexa application), the user may automate activation and/or modulation of various devices (e.g., lights, thermostat, etc.) within the indoor environment 103 based on the location of the UE 102 within the indoor environment 103 as represented by the labeled floor plan. For example, if the UE 102 is located within a predetermined distance from the kitchen, the client mapping application 154 and/or other application can activate lights in the kitchen. The automatic activation and/or modulation of electronic devices in this way can improve convenience of using the electronic devices.

In some implementations, the client mapping application 154 can provide navigation directions within the indoor environment 103 to the user. In reference to FIG. 1D, the UE 102 can perform method 180 to present indoor navigation directions at the UE 102 via the client mapping application 154. The method 180 can be implemented in a set of instructions stored on a computer-readable memory and executable at one or more processors of the UE 102.

Initially, at block 181, the UE 102 receives a request (e.g., from a user via user interface 156) for indoor navigation directions to a destination location within a building (e.g., the indoor environment 103). For example, the UE 102 may include user controls for requesting indoor navigation directions to the destination according to a shortest path, and/or user controls for requesting indoor navigation directions to the destination according to the shortest amount of time to reach the destination or least amount of traffic to the destination.

At block 182, the UE 102 communicates a UWB signal (e.g., any one or more of the first UWB signal 113A, second or third UWB signals over respective UWB links 114, 115) with at least one anchor device (e.g., any one or more of the anchor devices 104A, 104B, 104C) in an indoor positioning system (e.g., indoor positioning system 100) having a predetermined location (e.g., L_{A}, L_{B}, and L_{C}) within the indoor positioning system. In some implementations, in response to receiving the request at block 181, the controller 152 of the UE 102 can communicate the UWB signal with the at least one anchor device at block 182.

At block 183, the UE 102 determines a distance (e.g., D_{UA}, D_{UB}, D_{UC}) between the UE 102 and the at least one anchor device based on a RTT associated with the UWB signal. In some implementations, the UE 102 (e.g., controller 152) can calculate the RTT based on a period of time during which the UE 102 communicates the UWB signal at block 182 and in response receives a UWB response signal (e.g., any one or more of the first UWB response signal 113B, second and third UWB response signals over the respective UWB links 114, 115) from the at least one anchor device, as described above in FIG. 1C. Then, the UE 102 can determine the distance between the UE 102 and the at least one anchor device based on the calculated RTT and the speed of light (c), as described above in FIG. 1C.

At block 184, the UE 102 determines its indoor location (e.g., L_{UE}) based on (i) the distance between the UE 102 and the at least one anchor device determined at block 183 and (ii) the predetermined location (e.g., L_{A}, L_{B}, and L_{C}) for the at least one anchor device.

At block 185, the UE 102 generates a set of indoor navigation directions for traversing from its indoor location to the destination location along a route, and subsequently, at block 186, the UE 102 presents the indoor navigation directions via a user interface (e.g., user interface 156). In some implementations, the set of indoor navigation directions can be in the form of display data or audio data, such that the UE 102 can display and/or vocalize (e.g., via user interface 156) the navigation directions. In some implementations, the navigation directions may be in text form (e.g., “walk 200 feet and then turn right”). In other implementations, the navigation directions may visually depict the route (e.g., in two or three dimensions).

In some implementations, the route may be visually superimposed on one of the floor plans 148 generated by the network server 105. In one such implementation, the UE 102 can forward the request for indoor navigation directions received at block 181 to the network server 105 (e.g., backend mapping application 144). In turn, the network server 105 can receive and process the request to generate the requested navigation directions using indoor map data (e.g., indoor feature data, pedestrian traffic data, floor plans 148) and location data (i.e., L_{UE}) collected from the UE 102 over time that are stored in memory (e.g., processing hardware 140). Based on the indoor map data, the network server 105 can generate navigation directions that include the shortest navigable path between the current location of the UE 102 and the user's desired destination, and/or the most efficient (i.e., and not necessarily the shortest) navigable path between the current location of the UE 102 and the user's desired destination in view of the pedestrian traffic data. The network server 105 can then provide the requested navigation directions to the UE 102 in response to its request, so that the UE 102 can render the requested navigation directions via the user interface 156. The use of floor plan and/or shortest navigable path and/or pedestrian traffic data provides improved navigation directions to the user for performing the technical task of moving to a desired destination.

In some implementations, the network server 105 (e.g., backend mapping application 144) can provide the indoor map data to the UE 102 in response to its request at block 181, so that the UE 102 can generate the navigation directions at block 185 using the indoor map data and its current location (L_{UE}).

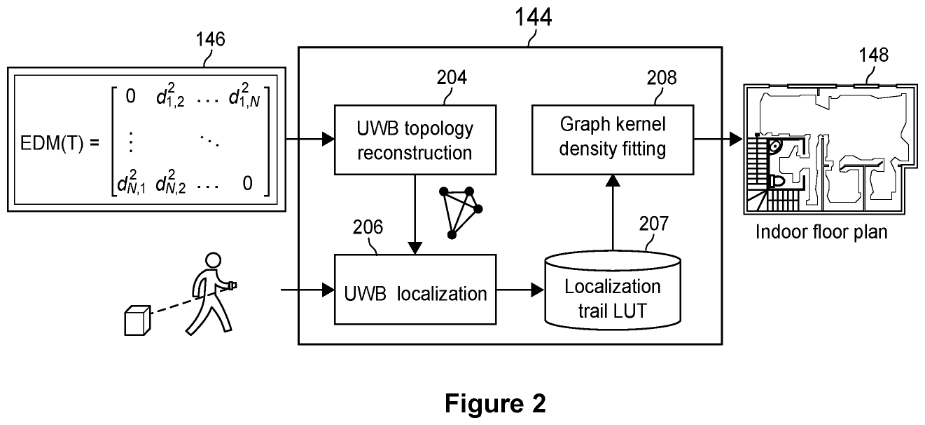

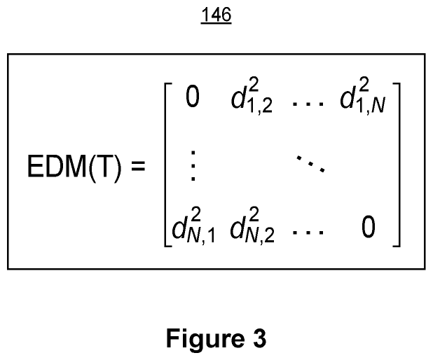

To determine the indoor location of a user, provide indoor navigation directions or other indoor mapping information, and/or perform indoor map-based home assistant actions, the indoor positioning system 100 automatically calibrates the locations of the anchor devices within a building, and automatically generates an indoor floor plan for the building. FIG. 2 illustrates an example backend mapping application 144, including several function blocks, to automatically calibrate the locations of the anchor devices and generate one of the indoor floor plans 148 of the indoor environment 103. As shown in FIG. 2, to calibrate the locations of the anchor devices, the indoor positioning system 100 generates a Euclidean distance matrix 146 indicating the distances between each pair of anchor devices, and transforms the distances into locations of the anchor devices to reconstruct an absolute network topology 204 of the anchor devices. This is described in more detail below with reference to FIGS. 3-5.

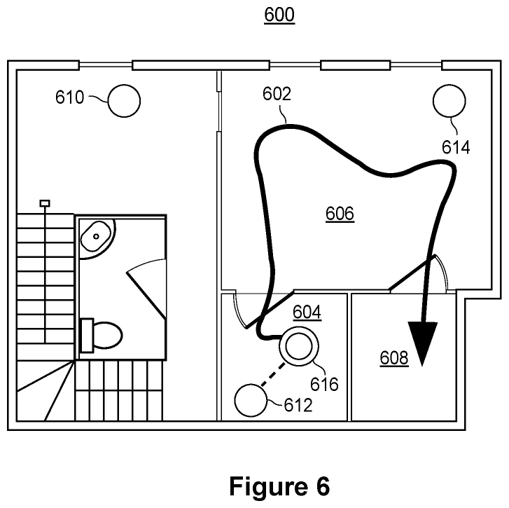

After calibrating the locations of the anchor devices, the indoor positioning system 100 determines the indoor locations 206 of UE(s) 102 based on distances from the UE 102 to each of the anchor devices and the respective locations of the anchor devices within the absolute network topology. Then the indoor positioning system 100 creates a localization trail 207 based on the trajectories of one or more users within the building. Next, the indoor positioning system 100 clusters the indoor locations of the users into several clusters, using graph kernel density fitting 208 for example. The indoor positioning system 100 then creates the indoor floor plan 148 using the clusters. This is described in more detail below with reference to FIGS. 6-11.

As mentioned above, to determine the indoor location of a user in a building, the indoor positioning system 100 includes one or more anchor devices placed within the building that communicate UWB signals with the user's UE 102. Prior to communicating with a UE 102, the anchor devices communicate UWB signals with each other to calibrate their respective locations in the building. Then the anchor devices store their respective locations or transmit their respective locations to a network server 105, which are then used to determine the indoor location of a UE 102.

More specifically, the anchor devices determine their distances from each other in the manner described above with reference to FIG. 1B. Then the lead anchor device or the network server 105 transforms the distance measurements into respective locations within the building of each of the anchor devices 104A-104C by, for example using a Euclidean Distance Matrix (EDM). An example EDM 146 is shown in FIG. 3. Each row of the EDM 146 includes squared pairwise distance measurements from a particular anchor device to each of the other anchor devices. For example, the first row of the EDM 146 includes the square of the distance from the first anchor device to the first anchor device (zero), the square of the distance from the first anchor device to the second anchor device (d²_{1,2}), . . . , and the square of the distance from the first anchor device to the N^{th} anchor device (d²_{1, N}). The N^{th} row of the EDM 146 includes the square of the distance from the N^{th} anchor device to the first anchor device (d²_{N,1}), the square of the distance from the N^{th} anchor device to the second anchor device (d²_{N,2}), . . . , and the square of the distance from the N^{th} anchor device to the N^{th} anchor device (zero). In this matrix 146, each of the diagonal entries is zero since there is no distance between an anchor device and itself. Moreover, none of the entries are negative since the distance is squared, and the matrix is symmetrical since the distance from a first anchor device to a second anchor device is the same as the distance from the second anchor device to the first anchor device.

The lead anchor device or the network server 105 can then reconstruct an absolute network topology from the EDM 146 by determining respective locations of each of the anchor devices using Eigenvalue Decomposition (EVD). More specifically, the lead anchor device or the network server 105 generate a centering matrix having the same size as the EDM 146. Since the EDM 146 is an N×N matrix, the centering matrix is also an N×N matrix, having diagonal values of

$$1 - \frac{1}{N} ,$$

the remaining values of

$$- \frac{1}{N} .$$

For example, when there are three anchor devices as in Fig. Y, the centering matrix is:

$$[ \begin{matrix}\frac{2}{3} & - \frac{1}{3} & - \frac{1}{3} \\ - \frac{1}{3} & \frac{2}{3} & - \frac{1}{3} \\ - \frac{1}{3} & - \frac{1}{3} & \frac{2}{3}\end{matrix} ]$$

The lead anchor device or the network server 105 may then combine the centering matrix with the EDM 146 to generate a Gram matrix. The Gram matrix may be computed using the following equation:

G=−0.5C EDM(T)C
where:
G is the Gram matrix,
C is the centering matrix, and
EDM(T) is the Euclidean distance matrix.

The resulting Gram matrix is also an N×N matrix. Then the lead anchor device or the network server 105 performs an eigenvalue decomposition of the resulting Gram matrix to generate a series of eigenvalues λ₁ to λ_{N} representative of the locations of each anchor device. For example, the square root of the first eigenvalue \sqrt{λ₁} may indicate the location of the first anchor device, L_{A} . . . , and the square root of the N^{th} eigenvalue \sqrt{λ_{N}} may indicate the location of the N^{th} anchor device, L_{N}.

The lead anchor device or the network server 105 can then generate an absolute network topology of the anchor devices based on their determined locations. More specifically, the lead anchor device or the network server 105 may identify an orthonormal basis for the Gram matrix and apply the orthonormal basis to the square roots of the eigenvalues λ₁ to λ_{N} to determine two-dimensional coordinate positions of each anchor device.

Then for each anchor device, the lead anchor device or the network server 105 may store location information for the respective anchor device within the absolute network topology along with identification information for the respective anchor device. The lead anchor device or the network server 105 may also transmit the location information to the respective anchor devices. In this manner, when a UE 102 determines its location (L_{UE}) by communicating with the anchor devices 104A-104C, each anchor device 104A-104C can include an indication of its respective location (L_{A}, L_{B}, L_{C}), for example in the UWB response signal 113B or in another message. Then the UE 102 can determine its location (L_{UE}) based on the distances from the UE 102 to the anchor devices 104A-104C (D_{UA}, D_{UB}, D_{UC}), and the locations of the anchor devices 104A-104C (L_{A}, L_{B}, L_{C}) indicated in the UWB response signals 113B or other messages. In other implementations, the UE 102 can receive the locations (L_{A}, L_{B}, L_{C}) of the respective anchor devices 104A-104C from the network server 105 or from the lead anchor device.

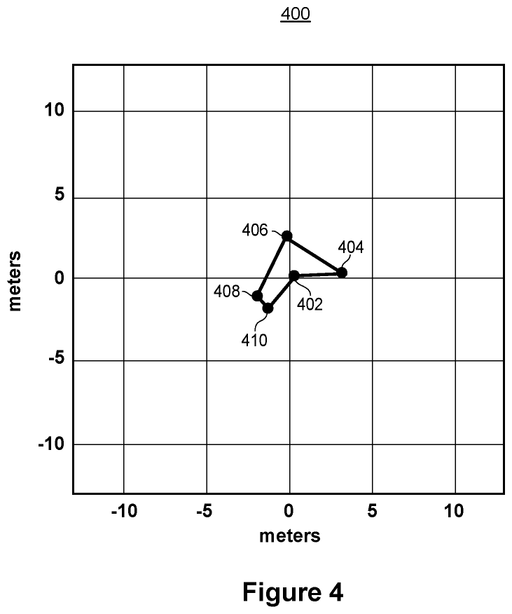

The topology may be aligned post reconstruction to match the optimal rotation, mirroring, and translation for visualization purposes. FIG. 4 illustrates an example absolute network topology 400 for five anchor devices 402-410. The lead anchor device or the network server 105 determines that a first anchor device 402 is located at the center of the building at coordinate location (0, 0). The second anchor device 404 is located about four meters away from the first anchor device 402 at about coordinate location (4 m, 0). The third anchor device 406 is located at about coordinate location (0, 3 m), the fourth anchor device 408 is located at about coordinate location (−2 m, −1 m), and the fifth anchor device 410 is located at about coordinate location (−1 m, −2 m).

The x,y coordinates may represent east-west coordinates and north-south coordinates respectively, or may represent any suitable direction. By generating an absolute network topology 400 of the anchor devices, the indoor positioning system 100 can determine the indoor location of a UE 102 within the building based on its distances from the locations of the respective anchor devices. The indoor positioning system 100 can also provide indoor navigation directions to a user whose destination location is at a particular coordinate position within the building. Moreover, the indoor positioning system 100 can identify when the user is in a particular room or area having a boundary indicated by a set of coordinates. Then the indoor positioning system 100 can perform a particular action requested by the user when the user is in that particular room or area, provide coupons or targeted advertisements to the user specific to the particular room or area, or perform any other suitable action based on the indoor location of the user.

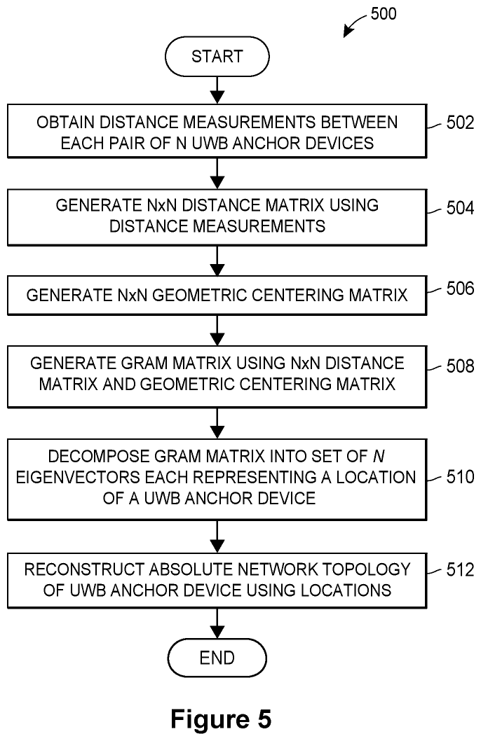

FIG. 5 illustrates a flow diagram of an example method 500 for calibrating positions of anchor devices in an indoor positioning system 100. The method 500 can be implemented in a set of instructions stored on a computer-readable memory and executable at one or more processors of an anchor device 104A-104C, such as a lead anchor device. In other implementations, the method 500 can be executed at one or more processors of a network server 105.

At block 502, a distance measurement is obtained between each pair of N anchor devices. For example, if there are N anchor devices, a total of N×(N−1)/2 pairwise distance measurements are obtained. The pairwise distance measurements may be obtained from each pair of anchor devices communicating a UWB signal and a UWB response signal between the pair. The pair of anchor devices may determine the distance from one to the other based on the round trip time of the UWB signal and the UWB response signal communicated between the pair. Then at least one of the anchor devices 104A-104C in the pair may provide the distance measurement to the lead anchor device or the network server 105.

At block 504, an N×N distance matrix (an EDM) is generated using the distance measurements. Each row of the N×N distance matrix includes squared pairwise distance measurements from a particular anchor device 104A-104C to each of the other anchor devices 104A-104C. For example, the first row of the N×N distance matrix includes the square of the distance from the first anchor device 104A to the first anchor device 104A (zero), the square of the distance from the first anchor device 104A to the second anchor device 104B (d²_{1,2}), . . . , and the square of the distance from the first anchor device 104A to the N^{th} anchor device (d²_{1,N}). The N^{th} row of the N×N distance matrix includes the square of the distance from the N^{th} anchor device to the first anchor device 104A (d²_{N,1}), the square of the distance from the N^{th} anchor device to the second anchor device 104B (d²_{N,2}), . . . , and the square of the distance from the N^{th} anchor device to the N^{th} anchor device (zero).

A geometric centering matrix (C) is also generated (block 506), where the centering matrix is an N×N having diagonal values of

$$1 - \frac{1}{N} ,$$

and the remaining values of

$$- \frac{1}{N} .$$

Then a Gram matrix (G) is generated by combining the distance matrix with the centering matrix (block 508). More specifically, the Gram matrix may be computed as G=−0.5 C EDM(T) C. The Gram matrix is then decomposed into a set of N eigenvalues by performing an eigenvalue decomposition on the Gram matrix (block 510). The N eigenvalues λ₁ to λ_{N} represent the locations of each anchor device 104A-104C. For example, the square root of the first eigenvalue \sqrt{λ₁} may indicate the location of the first anchor device 104A, L_{A} . . . , and the square root of the N^{th} eigenvalue \sqrt{λ_{N}} may indicate the location of the N^{th} anchor device, L_{.}

At block 512, an absolute network topology of anchor devices 104A-104C is reconstructed using the eigenvalues. For example, an orthonormal basis for the Gram matrix may be identified and the orthonormal basis may be applied to the square roots of the eigenvalues λ₁ to λ_{N} to determine two-dimensional coordinate positions of each anchor device 104A-104C. Then the indoor positioning system 100 can determine the indoor location of a UE 102 within the building and provide navigation directions using the locations of the respective anchor devices 104A-104C and the distances from the UE 102 to each anchor device 104A-104C.

Once the anchor devices 104A-104C have been calibrated, the indoor positioning system 100 can determine the location of a user within the building. The indoor positioning system 100 can then map the trajectories of multiple users walking around the building to automatically generate an indoor floor plan which may include representations of walls, doors, entrances, exits, etc. Then the indoor positioning system 100 may store the indoor floor plan and provide the indoor floor plan to users in the building for display on their UEs 102, for example when requesting indoor map and/or navigation data.

The indoor positioning system 100 may obtain the trajectories of one or more users walking around the building as training data to automatically generate the indoor floor plan. For example, a one or more users may agree to provide anonymized indoor location data to the network server 105 which may be used to generate the indoor floor plan. Then when each of the users is walking within the building their respective UEs 102 periodically or continuously transmit their indoor locations to the network server 105. The network server 105 then collects the training data over a particular training period (e.g., an hour, a day, a week, etc.) and generates the indoor floor plan using the training data. In some implementations, after the training period has been completed, the network server 105 stops receiving indoor location data from users to generate the indoor floor plan. In other implementations, after the training period has been completed, the network server 105 may continue to receive indoor location data and update the indoor floor plan based on additional data. In yet other implementations, the network server 105 stops receiving indoor location data for a threshold time period. Once the threshold time period has expired, the network server 105 may once again receive indoor location data, generate a new indoor floor plan based on the most recent indoor location data, and compare the new indoor floor plan to the previous indoor floor plan. If the two indoor floor plans are the same or share an amount of similarity that is within a similarity threshold, the network server 105 may not change the previous version of the indoor floor plan. Otherwise, the network server 105 updates the indoor floor plan to the new version of the indoor floor plan and stores the new version.

FIG. 6 illustrates a schematic diagram 600 of an example trajectory 602 of a user within a building determined using UWB signals communicated between the user's UE 616 and the anchor devices 610-614. The trajectory 602 may include indoor locations which are determined continuously or periodically (e.g., every second, every 15 seconds, every minute, etc.). In the example trajectory 602, the user begins in a first room 604, exits the first room 604 and enters a second room 606, and then exits the second room 606 and enters a third room 608. For example, the first room 604 and the third room 608 may be offices and the second room 606 may be a common area. The network server 105 may receive each of these locations and infer that the locations on the trajectory 602 cannot be walls. While one trajectory from a single user may not provide enough information to generate an accurate indoor floor plan, the network server 105 may receive multiple trajectories of a single user, a single trajectory of multiple users, or multiple trajectories of multiple users, for example over the course of a day, a week, a month, etc., to generate the indoor floor plan.

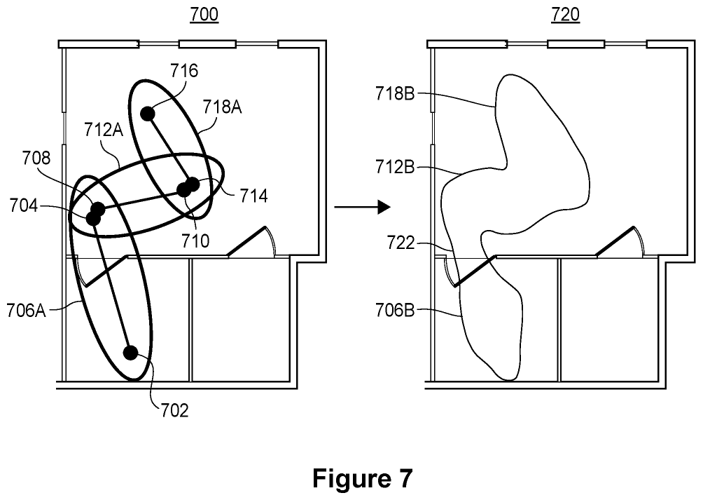

In any event, once the training data has been collected, the network server 105 may cluster the training data into a set of clusters. The clusters may then be used to identify rooms, walls, entrances, exits, etc. More specifically, the network server 105 may use graph kernel density fitting to convolve locations on the trajectories with a kernel function such as a directional Gaussian. This generates a smooth representation of the location data. FIG. 7 illustrates a schematic diagram 700 of trajectories of users, where neighboring locations on the trajectories or nodes 702, 704 are convolved with a directional Gaussian 706A. As shown in FIG. 7, rather than generating a line between two neighboring nodes 702, 704, the network server 105 generates a directional Gaussian distribution 706A around the two neighboring nodes 702, 704 smoothing out the line between the two nodes 702, 704 into several possible locations for a user. The network server 105 also generates another directional Gaussian distribution 712A around the two neighboring nodes 708, 710, and yet another directional Gaussian distribution 718A around the two neighboring nodes 714, 716. The schematic diagram 720 illustrates the combined Gaussian distributions 706B, 712B, and 718B generated by the network server 105.

The network server 105 may then cluster the combined Gaussian distributions into a set of clusters, for example using a k-means or a kernel k-means algorithm. In the k-means or k-means algorithm, the network server 105 assigns an indoor location to the cluster having a centroid that is closest to the indoor location. The centroid of a cluster may be the mean of the cluster's locations. In any event, the network server 105 may generate the indoor floor plan based on the clusters. For example, the network server 105 may determine each cluster represents a room. The network server 105 may also determine that there are walls in locations that are not assigned to any cluster. Furthermore, the network server 105 may identify entrances/exits between rooms or hallways when there is a bottleneck 722 between clusters or connecting clusters, where the width of the trajectories narrows.

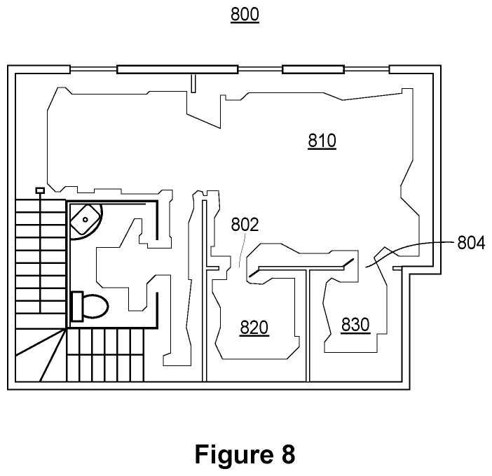

This is illustrated in more detail in FIG. 8 which depicts another example indoor floor plan 800 generated by clustering user's location histories. At locations 802 and 804 the width of the trajectories narrows at the intersection of clusters 810 and 820 and 810 and 830, respectively. Each of these clusters 810, 820, 830 indicates a separate room with the bottleneck areas 802, E04 indicating entrances/exits between the rooms 810, 820, 830.

In any event, the network server 105 may periodically receive indoor location data (e.g., every day) and at the end of each day generate a new indoor floor plan based on the previous indoor location data and the additional indoor location data collected for the day. The network server 105 may compare the new indoor floor plan to the previous indoor floor plan. When the difference is less than a difference threshold, the network server 105 may continue to use the previous indoor floor plan. In some implementations, the network server 105 may stop receiving training data at this point.

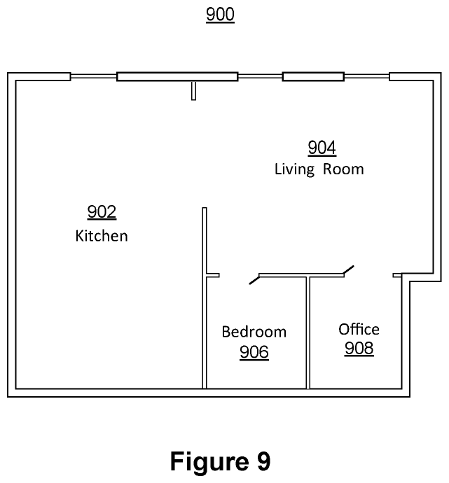

A user may also label rooms in the building using the indoor floor plan. For example, the network server 105 may provide the indoor floor plan for display on the user's UE 102. The user may then indicate via user controls that one room is a bedroom while another is an office. An example indoor floor plan 900 presented on a user's UE 102 is illustrated in FIG. 9. The example indoor floor plan 900 includes a kitchen 902, a living room 904, a bedroom 906, and an office 908. The UE 102 may include user controls for the user to touch-select each room, for example, and enter in a name for the room or to select pre-stored room names from a drop-down menu. The user may be able to label the rooms in any suitable manner, such as “Mike's Bedroom” or “The Fun Zone.” In other implementations, a user may label rooms by physically walking from one room to the next and communicating the label for the room that the user is physically in with the UE 102 or the anchor device 104A-104C, via a voice instruction or entering text. The UE 102 or anchor device 104A-104C may transmit this information to the network server 105 which may then label the indoor floor plan with the name provided by the user at the room that the user is physically located.

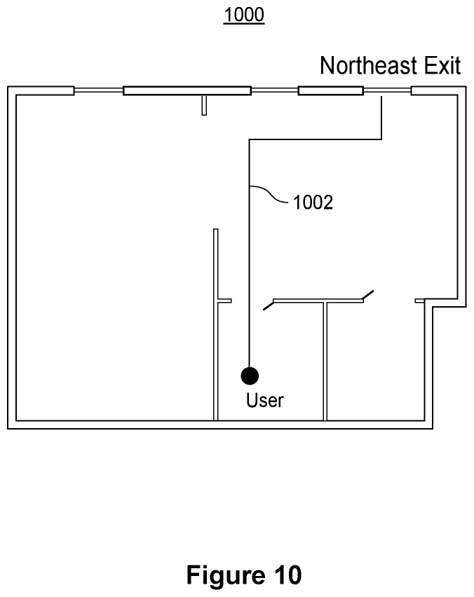

Then when a user requests indoor navigation directions, the user may enter one of the labeled rooms as the destination location. For example, in the navigation display 1000 as shown in FIG. 10, a user may request navigation directions from her current location to the northeast exit of the building. The northeast exit may have been labeled previously by the user or by another user. In some implementations, the navigation display 1000 may present the labels in the indoor floor map so that the user can request navigation directions to a labeled location via user controls. In other implementations, the user may enter in a request for navigation directions to a particular destination location which may correspond to a labeled location. The UE 102 may identify a labeled location which matches the user's requested location or if the requested location is ambiguous may present multiple labeled locations for the user to choose from. For example, if the user requests navigation directions to “the north exit,” the UE 102 may present user controls for the user to select either the northeast exit or the northwest exit.

In any event, the network server 105 may generate a set of navigation directions for traversing a route from the user's current location to the destination location. The network server 105 may generate the set of navigation directions for traversing the route as the shortest navigable path from the current location to the destination location which avoids walls and other obstructions. For example, the network server 105 may store a set of route segments for traversing each adjacent pair of rooms, from one hallway to the next, from one corner of a room to another, etc. without obstructions, such as walls. The network server 105 may then use the stored route segments and their respect lengths (e.g., in meters) to generate the route. The network server 105 then provides the set of navigation directions to the UE 102 which presents an indication of the route 1002 to the northeast exit.

In other implementations, the network server 105 may generate the set of navigation directions for traversing the route in the shortest amount of time and/or in the most efficient manner. For example, the network server 105 may generate the set of navigation directions by taking into account pedestrian traffic data.

In any event, as the user traverses the route, the UE 102 may continue to determine the user's indoor location. If the user's indoor location is away from the route by more than a threshold distance, the UE 102 may recalculate the route by transmitting the user's updated location to the network server 105.

In addition to providing navigation directions, the user may request an anchor device 104A-104C or another home assistant device to perform an indoor map-based home assistant action in a particular labeled room. Furthermore, the user may provide a preset rule that each time the user enters a particular labeled room, a home assistant device should perform an indoor map-based home assistant action in the particular labeled room. Then when the user's location corresponds to a location within the particular labeled room, the home assistant device performs the indoor map-based home assistant action (e.g., turns on the lights in that room). Moreover, when the building is a department store or other commercial building, the UE 102 may present location-based announcements specific to the room or area in which the user is located. For example, the user may select an option to share her indoor location to a network server 105 to receive location-based coupons. Then when the user is in a particular aisle of a store for example, the UE 102 may receive coupons for products in the aisle from the network server 105 or another server that receives the user's indoor location information.

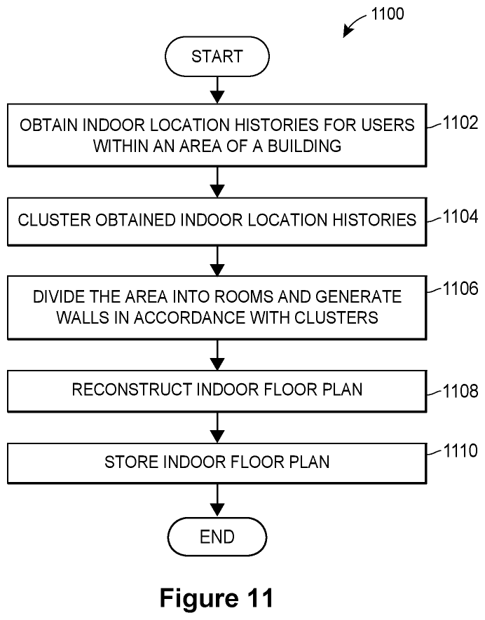

FIG. 11 illustrates a flow diagram of an example method 1100 for automatically generating an indoor floor plan. The method 1100 can be implemented in a set of instructions stored on a computer-readable memory and executable at one or more processors of a network server 105.

At block 1102, the network server 105 obtains location histories for users within an area of a building, such as a particular floor of the building. The network server 105 may obtain the trajectories of users walking around the building as training data to automatically generate the indoor floor plan. For example, a set of users may agree to provide indoor location data to the network server 105 which may be used to generate the indoor floor plan. Then when each of the users is walking within the building their respective UEs 102 periodically or continuously transmit their indoor locations to the network server 105. The network server 105 then collects the training data over a particular training period (e.g., an hour, a day, a week, etc.).

Then after the particular training period has occurred, the network server 105 clusters the indoor locations into a set of clusters corresponding to different rooms or areas (block 1104). The clusters may then be used to identify rooms, walls, entrances, exits, etc. More specifically, the network server 105 may use graph kernel density fitting to convolve locations on the trajectories with a kernel function such as a directional Gaussian. This generates a smooth representation of the location data. The network server 105 may then cluster the combined Gaussian distributions into a set of clusters, for example using a k-means or a kernel k-means algorithm. In the k-means or k-means algorithm, the network server 105 assigns an indoor location to the cluster having a centroid that is closest to the indoor location.

Then at block 1106, the network server 105 may divide the area into rooms and generate representations of walls for the indoor floor plan in accordance with the clusters. For example, the network server 105 may determine each cluster represents a room. The network server 105 may also determine that there are walls in locations that are not assigned to any cluster. Furthermore, the network server 105 may identify entrances/exits between rooms or hallways when there is a bottleneck between clusters or connecting clusters, where the width of the trajectories narrows.

The network server 105 then reconstructs or generates the indoor floor plan using the identified walls, entrances/exits, etc. (block 1108). Then the network server 105 stores the indoor floor plan for use in providing indoor map and/or navigation data to the UE 102 (block 1110). For example, the network server 105 may generate route segments for traversing various portions of the area to avoid obstructions and may determine the lengths of the route segments or assign weights to the route segments in any other suitable manner. Then when a user requests indoor navigation directions, the network server 105 may generate a route corresponding to the shortest navigable path from the user's current location to the destination location based on the route segments and their corresponding weights. The network server 105 may also use the stored indoor floor plan to perform an indoor map-based home assistant action in a particular labeled room or to perform an indoor map-based home assistant action in response to determining that the user is currently in a particular labeled room.

Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms (e.g., controllers 132A, 142, 152). Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The methods 180, 500, and 1100 may include one or more function blocks, modules, individual functions or routines in the form of tangible computer-executable instructions that are stored in a computer-readable storage medium, which may be non-transitory, and executed using a processor of a computing device (e.g., a network server, a personal computer, a smart phone, a tablet computer, a smart watch, a mobile computing device, an anchor device, a home assistant device or other client computing device, as described herein). The methods 180, 500, and 1100 may be included as part of any backend server (e.g., a network server or any other type of server computing device, as described herein), client computing device modules of the example environment, for example, or as part of a module that is external to such an environment. Though the figures may be described with reference to the other figures for ease of explanation, the methods 180, 500, and 1100 can be utilized with other objects and user interfaces. Furthermore, although the explanation above describes steps of the methods 180, 500, and 1100 being performed by specific devices (such as a network server, a UE, or an anchor device), this is done for illustration purposes only. The blocks of the methods 180, 500, and 1100 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for an indoor positioning system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for providing indoor navigation directions to a user, the method comprising:
receiving, at one or more processors in a client device, a request for indoor navigation directions to a destination location within a building;
communicating, by the one or more processors, an ultra-wideband (UWB) signal with at least one anchor device in an indoor positioning system having a predetermined location within the indoor positioning system;
determining, by the one or more processors, a distance between the client device and the at least one anchor device based on a round trip time associated with the UWB signal;
determining an indoor location of the client device based on (i) the distance between the client device and the at least one anchor device and (ii) the predetermined location for the at least one anchor device;
generating, by the one or more processors, a set of indoor navigation directions for traversing from the indoor location of the client device to the destination location along a route; and
providing the indoor navigation directions via a user interface of the client device.

2. The method of claim 1, wherein communicating the UWB signal with at least one anchor device includes communicating the UWB signal with a plurality of anchor devices, and
wherein determining the indoor location of the client device includes determining the indoor location of the client device using multilateration according to distances between the client device and each of the plurality of anchor devices.

3. The method of claim 2, wherein determining the indoor location of the client device includes:
determining, using a maximum likelihood estimation (MLE), the indoor location of the client device according to distances between the client device and each of the plurality of anchor devices and estimated errors in the distances.

4. The method of claim 1, wherein
the at least one anchor device includes a plurality of antennas for communicating the UWB signal with the client device, and
determining the indoor location of the client device includes:
transmitting the UWB signal to the plurality of antennas at the at least one anchor device;
receiving a UWB response signal from the at least one anchor device including an indication of a direction of arrival of the UWB signal; and
determining the indoor location of the client device based on the (i) the distance between the client device and the at least one anchor device, (ii) the predetermined location for the at least one anchor device, and (iii) the direction of arrival of the UWB signal.

5. The method of claim 1, wherein:
the client device includes a plurality of antennas for communicating the UWB signal with the at least one anchor device, and
determining the indoor location of the client device includes:
receiving a UWB response signal from the at least one anchor device at each of the plurality of antennas;
determining a direction of arrival of the received UWB response signal based on a time difference at which each of the plurality of antennas received the UWB response signal; and
determining the indoor location of the client device based on the (i) the distance between the client device and the at least one anchor device, (ii) the predetermined location for the at least one anchor device, and (iii) the direction of arrival of the received UWB response signal.

6. The method of claim 1, wherein determining the distance between the client device and the at least one anchor device includes:
sending the UWB signal to the at least one anchor device;
receiving a UWB response signal from the at least one anchor device; and
calculating the round trip time based on time elapsed from sending the UWB signal to receiving the UWB response signal.

7. The method of claim 1, wherein generating the set of indoor navigation directions includes:
accessing floor plan data corresponding to at least a portion of a floor plan of the building; and
generating the indoor navigation directions based on the floor plan data.

8. The method of claim 7, wherein the route is a shortest navigable path between the indoor location of the client device to the destination location.

9. The method of claim 8, further comprising:
providing an option in the user interface for a user to select the shortest navigable path.

10. The method of claim 1, wherein generating the set of indoor navigation directions includes:
accessing traffic data corresponding to pedestrian traffic within the building; and
generating the indoor navigation directions based on the traffic data.

11. The method of claim 10, wherein the route is a least traffic path between the indoor location of the client device to the destination location.

12. The method of claim 11, further comprising:
providing an option in the user interface for a user to select the least traffic path.

13. The method of claim 7, further comprising:
receiving a second request to label the floor plan of the building with one or more identifiers;
modifying the floor plan data based on the one or more identifiers, and optionally
providing at least part of the modified floor plan data to the user via the user interface together with the indoor navigation directions.

14. The method of claim 11, further comprising:
receiving a third request to automate activation of one or more electronic devices included in the indoor environment; and
when the indoor location of the client device is within a predetermined distance of the one or more electronic devices, causing activation and/or modulation of the one or more electronic devices.

15. A system for providing indoor navigation directions to a user, the system comprising:
one or more anchor devices each configured to:
receive a UWB signal from a client device;
provide a UWB response signal to the client device to cause the client device to determine an indoor location of the client device based on a round trip time of the UWB signal and the UWB response signal; and
a server device including:
one or more processors; and
a memory including computer executable instructions that, when executed by the one or more processors, cause the server device to:
receive a request for indoor navigation directions from the indoor location of the client device to a destination location within a building;
generate a set of indoor navigation directions for traversing from the indoor location of the client device to the destination location along a route; and
provide the indoor navigation directions to the client device.

16. The system of claim 15, wherein at least one of the anchor devices is further configured to provide an indication of a predetermined location of the at least one anchor device to the client device.

17. The system of claim 15, wherein to generate the set of indoor navigation directions, the instructions cause the server device to:
access floor plan data corresponding to at least a portion of a floor plan of the building; and
generate the indoor navigation directions based on the floor plan data.

18. The system of claim 17, wherein the route is a shortest navigable path between the indoor location of the client device to the destination location.

19. The method of claim 15, wherein to generate the set of indoor navigation directions, the instructions cause the server device to:
access traffic data corresponding to pedestrian traffic within the building; and
generate the indoor navigation directions based on the traffic data.

20. The method of claim 19, wherein the route is a least traffic path between the indoor location of the client device to the destination location.

21. A method for determining an indoor location of a user, the method comprising:
communicating, by one or more processors in a client device, an ultra-wideband (UWB) signal with at least one anchor device in an indoor positioning system having a predetermined location within the indoor positioning system;
determining, by the one or more processors, a distance between the client device and the at least one anchor device based on a round trip time associated with the UWB signal; and
determining, using a maximum likelihood estimation (MLE), an indoor location of the client device based on (i) the distance between the client device and the at least one anchor device, (ii) an estimated error in the distance, and (iii) the predetermined location for the at least one anchor device.

22. The method of claim 21, wherein communicating the UWB signal with at least one anchor device includes communicating the UWB signal with a plurality of anchor devices, and
wherein determining the indoor location of the client device includes determining the indoor location of the client device using multilateration according to distances between the client device and each of the plurality of anchor devices.

23. The method of claim 21, wherein:
the client device includes a plurality of antennas for communicating the UWB signal with the at least one anchor device, and
determining the indoor location of the client device includes:
receiving a UWB response signal from the at least one anchor device at each of the plurality of antennas;
determining a direction of arrival of the received UWB response signal based on a time difference at which each of the plurality of antennas received the UWB response signal; and
determining the indoor location of the client device based on the (i) the distance between the client device and the at least one anchor device, (ii) the estimated error in the distance, (iii) the predetermined location for the at least one anchor device, and (iv) the direction of arrival of the received UWB response signal.

24. The method of claim 21, wherein determining the distance between the client device and the at least one anchor device includes:
sending the UWB signal to the at least one anchor device;
receiving a UWB response signal from the at least one anchor device; and
calculating the round trip time based on time elapsed from sending the UWB signal to receiving the UWB response signal.
